(19) United States
(12) Patent Application Publication
(10) Pub. No.: US 2026/0334349 A1
(43) Pub. Date: Oct. 29, 2026

(54) METHOD OF TREATING SEEDS WITH GASES TO EXTRACT GENETIC POTENTIAL FOR INCREASED PRODUCTIVITY, AND EQUIPMENT

(71) Applicant: DIOXD APLICACAO DE TECNOLOGIANO TRATAMENTO DE SEMENTES LTDA, Londrina, Parana (BR)

(72) Inventor: João Américo Macori BARBOZA, Londrina, Parana (BR)

(21) Appl. No.: 19/123,013

(22) PCT Filed: Oct. 23, 2023
(86) PCT No.: PCT/BR2023/050359

§ 371 Date: Apr. 21, 2025

(30) Foreign Application Priority Data
Oct. 27, 2022 (BR) 1020220219524

(51) Int. Cl. A01C 1/00; A01N 59/00; A01N 59/04; A01P 13/00

(52) U.S. Cl. CPC A01C 1/00; A01N 59/00; A01N 59/04; A01P 13/00

(57) ABSTRACT

A method for treating seeds with a mixture of different gases to extract the genetic potential, resulting in improvements that increase productivity in different types of crops, and equipment for carrying out the method.

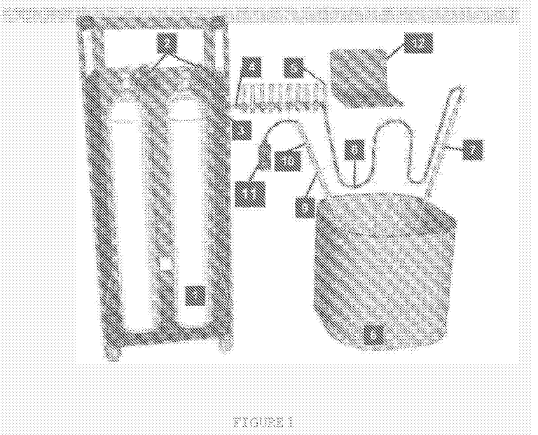

### FIELD OF INVENTION

The present invention refers to a technology for treating seeds with a mixture of different gases to extract the genetic potential, generating improvements that increase productivity in different types of crops.

### STATE OF ART

Over the years, several methods for treating seeds have been developed by the agricultural industry, which are aimed at different purposes.

There were improvements in seed storage, by means of refrigerated warehouses with temperature and humidity control. Seed cooling systems are used to increase the storage potential, helping to maintain the physiological quality indexes of the seed. Another method of seed processing is carried out by the use of phosphine gas, to control storage pests.

In addition, different management techniques are constantly implemented to reduce seed damage. Seeds with less damage represent a higher rate of vigor and germination. Among these management techniques, the application of fertilizers, soil management and the use of insecticides, fungicides, herbicides, and nematicides stand out. Another technique used is to make the seed harvesting speed slower to cause less mechanical damage. Three levels of management—economic level, control level and equilibrium level.

Liquid chemicals are also applied to protect the seeds against attacks by insects, fungi and diseases at the beginning of the cycle.

The use of liquid or granular fertilizers, which can be chemical or organic, applied in the planting or foliar furrow (or aerial spraying).

More recently, some treatment methods have been developed that consist of the application of gases to seeds, in order to increase the productivity thereof.

However, all the treatment methods mentioned have several complications and drawbacks to be executed. The main problems encountered occur due to the methods being expensive, time-consuming, having their execution complex, and also being harmful to the environment.

Therefore, there is a problem in the technique to be solved, which consists of finding a way to obtain high quality seeds, with high genetic potential, generating increased productivity, in which the method is not costly, slow and causes low environmental impacts.

### SUMMARY OF INVENTION

In view of the scenario presented, the present invention has as a technological solution the application of a gas compound in the pre-planting period, changing the seed atmosphere to extract the best genetic potential of the seeds in the field after the break of dormancy, improving the development of the plant in each phenological stage, obtaining as a final result the gain in productivity.

### DETAILED DESCRIPTION OF THE INVENTION

The treatment proposed by this invention comprises one or more cylinders (1) in which gases or gas mixtures are stored in a pressurized form. At the upper outlet of the cylinder (1), the flow is controlled by a pressure regulator (2) which is coupled to a high-pressure hose (3) directing the gases or gas mixture to a distribution ruler (4).

The distribution ruler (4) is composed of other pressure regulators (5) that individually control the flow of gases of gas mixtures by directing them, through a high-pressure hose (6), to the diffusers (7), which are inserted into bags or sacks (8).

Inside the bags or sacks, there are also inserted rods (9) having one or more sets of sensors (10) that are connected, by means of wires, to a transmitter (11) existing in the upper part of the rod (9). The transmitter (11) in turn collects and transmits the data to a device (12) that will interpret said data.

The cylinders (1) are filled with a mixture of CO2 (carbon dioxide), O2 (oxygen) and N2 (nitrogen) gases, whereby their concentrations can vary according to temperature, air humidity and seed compaction inside the bags or sacks. Preferably, the ratios of the gases are 55 to 75% CO2, 10 to 20% O2 and 15 to 45% N2. However, other ratios can be used, depending on the values obtained in the crossing of the data captured by the sensors.

The concentration of gases or gas mixtures in the seed storage structure varies from 100 to 100,000 ppm.

In the present invention, pressure regulators (2) work in pressure range between 0.5 and 15.9 Kgf/cm². The high-pressure hoses (3, 6) used withstand a pressure of 1 bat up to 1100 bar.

The distribution ruler (4) is filled with the gas or gas mixture coming from the cylinder (1) which are evenly distributed among the individual outlet pressure regulators (5).

In individual outlet pressure regulators(S), the pressure is maintained between 0.3 bar and 20 bar for a period of time according to Table 1 below.

TABLE 1

| Time | Pressure |
|---|---|
| (minutes) | (bar) |
| 0 to 10 | 8.7-20 |
| 10 to 25 | 6.4-8.7 |
| 25 to 40 | 5.3-6.4 |
| 40 to 55 | 4.7-5.3 |
| 55 to 70 | 3.5-4.7 |
| 70 to 85 | 2.9-3.5 |
| 85 to 100 | 2.5-2.9 |
| >100 | 0.3-2.5 |

The beginning of the treatment takes place in the final phase of storage, after the entire seed processing process has been carried out.

More specifically, this invention can be carried out up to 180 days before planting, during which period the seed is in a state of pre-dormancy. A state of pre-dormancy is understood as being the state in which the seed has its active metabolic capacity, but without germination capacity. The application of gases can be carried out in the sheds of Seed Processing Units (UBS) or in storage sheds within the farms.

The process begins with the filling out of a form with the technical data of the seeds, including: type of crop, variety, batch, expiration, quantity, if any type of previous chemical treatment has previously been used and the presence of inoculant. Such technical information is registered and stored in its own Software.

From the storage and registration of the data, the Software calculates the concentration ranges and the distribution time of the gases or the gas compound.

The release of gases occurs in an interval of 15 to 120 minutes, varying according to the classification of plants as shown in Table 2 below.

TABLE 2

| Classification | Time (minutes) |
|---|---|
| C3 Plants | 15 to 70 |
| C4 Plants | 50 to 120 |

The classification of C3 and C4 plants is due to the difference in the photosynthetic cycles. Plants classified as C3 (e.g. soybeans, beans, cotton and wheat) receive this nomenclature, because after the carbon dioxide fixation process an acid with 3 carbon molecules is formed. C4 plants (e.g. corn and sorghum) have 1 more carbon molecule after the CO2 fixation process.

The application of gases or gas mixtures in the seed treatment inside the bags or sacks (8) happens in such a way that the concentration of O₂ decreases, changing the environment/atmosphere around the seeds as the concentration of CO₂ and N₂ increases.

After this process of changing the environment/atmosphere, the seed, which is a living organism with a positive metabolism and respiratory rate, finds it difficult to continue its metabolic activity due to the absence of O2. Thus, as a defense mechanism of the seed to adapt to the environment, which is at low levels of O₂, its respiratory rate is decreased. This process causes the seed to absorb CO2 and N₂, releasing O₂ and fixing and increasing the concentration of carbon in the seed's energy matrix. The energy matrix is understood as being the place when energy and nutrients responsible for keeping the seed viable and ensuring its germination potential are stored.

After sowing the seeds in the field, the germination process begins with the absorption of water by the seed, increasing its moisture and breaking pre-dormancy. At this stage, the seed fully activates its metabolism, initiating physiological processes. Among the physiological processes carried out, the activity of the enzyme PEP Carboxylase stands out, which is responsible for the fization of carbon in the plant's cells.

In the seeds that have undergone the treatment of this invention there is a higher concentration of carbon in the energy matrix, and thus the activity of the enzyme PEP Carboxylase increases by up to 14 times.

The higher concentration of carbon in the plant cells will make a greater volume of CO₂ available for the Calvin cycle (the Calvin cycle consists of a series of reactions that fix and reduce carbon and synthesize sugars). With the arrival of a higher concentration of CO₂ in the Calvin cycle, the result will be greater energy production.

The plant with an intensified energy production has a greater rooting capacity, increasing its contact surface for absorption of water and macro and micro nutrients from the soil, which will be transported to the foliar structure of the plant. With the arrival of more nutrients, the plant has a greater capacity to develop reproductive structures, which will lead to an increase in productivity.

In addition, with the use of the proposed technology, it is possible to observe a significant increase in the leaf surface and an increase in the potential for branch formation. In the case of plants classified as oilseeds, it is possible to observe other benefits such as an increase in the number of nodes, pods, grains per plant and better yield in grain filling.

Thus, it is clear that the present invention, by proposing the application of gases or gas mixtures in seed treatment, promotes better performance enzymes in the physiological process, which triggers greater root development and formation of reproductive structures, generating a significant increase in agricultural productivity.

The rods (9) are inserted into bags or sacks to monitor temperature, humidity, gas concentration and internal pressure, among other indicators used.

The rods (9) can be made of stainless steel, carbon fiber, PVC, steel, galvanized steel, or any other metal or plastic alloy, among other material variations. The rods (9) have an external diameter ranging from 9 mm to 200 mmm, internal diameter from 7 mm to 140 mm, length from 10 cm to 250 cm.

Each of the rods (9) comprises five rows of holes at its lower end, near the tip, two rows of holes in the central part, and two rows of holes at the other end thereof. Other variations of hole configuration can be used, for better adaptation to variations in rod types.

At the upper end of the rod (9), a transmission board and battery are positioned to power sensors, which have the characteristics of reading data gas concentration, humidity, temperature and pressure, among other indicators used. The collected data is sent to the software itself in real time and is stored.

The data collected are used to calculate the ranges of concentration and distribution of gases or mixture of gases inside the seed storage site, that is, in bags, sacks or any other seed storage structure.

The diffusers (7) are inserted into bags or sacks (8) to distribute the gases or gas mixture.

Diffusers (7) can be made of stainless steel, aluminum, carbon fiber, PVC, steel, galvanized steel, or any other metal or plastic alloy, among other material variations. The diffusers (7) have external diameter ranging from 9 mm to 200 mm, internal diameter from 7 mm to 140 mm, length from 10 cm to 250 cm.

Each of the diffusers (7) comprises successive rows of holes along their length axis, whereby such holes may have any configuration, in order to best adapt to variations in the types of diffusers.

1. A composition of gases for treating seeds, wherein the gases comprise CO₂, N₂ and O₂, wherein an application of the gases is carried out at a pressure of 0.3 bar up to 20 bar, the gases or mixtures thereof being in ratios of:
55% to 75% CO₂;
15% to 45% of N₂; and
10% to 20% O₂.

2. The composition of claim 1, wherein a period of the application of the gases or mixtures thereof is 15 to 120 minutes.

3. The composition of claim 1, wherein a concentration of the gases or mixtures thereof is in a seed storage structure and ranges from 100 ppm to 100,000 ppm.

4. The composition of claim 1, wherein the application of the gases or mixtures thereof in the seed treatment is carried out in a pre-dormancy phase of the seeds.

5. The composition of claim 1, wherein the application of the gases or mixtures thereof is carried out in sheds of Seed Processing Units (UBS) or in storage sheds within farms.

6. The composition of claim 1, wherein the application of the gases or mixtures thereof takes place inside bags or sacks.

7. A method for treating seeds, comprising steps of:
directing a composition of gases for treating seeds to a distribution ruler starting from a cylinder;
forwarding the composition of gases through a high-pressure hose to diffusers that are inserted into bags or sacks;
inserting rods that have sensors connected to a transmitter in the bags or sacks; and
collecting data from the transmitter and transferring the data to a device;
wherein the composition of gases comprises the gases or mixtures thereof in ratios of 55% to 75% CO₂, 15% to 45% of N₂, and 10% to 20% O₂.

8. Equipment for carrying out the method of claim 7, comprising:
one or more cylinders;
one or more pressure regulators;
one or more high-pressure hoses;
one or more gas distribution rulers;
one or more diffusers;
one or more rods;
one or more sensor sets;
one or more transmitters; and
one or more devices for receiving the data.

9. The equipment of claim 8, wherein the one or more pressure regulators are configured to work in a pressure range between 0.5 Kgf/cm² and 15.9 Kgf/cm².

10. The equipment of claim 8, wherein the one or more high-pressure hoses are configured to withstand a pressure of 1 bar up to 1100 bar.

11. The equipment of claim 8, wherein the one or more rods are made of stainless steel, aluminum, carbon fiber, PVC, steel, galvanized steel, or any other metal or plastic alloy.

12. The equipment of claim 11, wherein the one or more rods have an external diameter ranging from 9 mm to 200 mm, an internal diameter from 7 mm to 140 mm, and a length from 10 cm to 250 cm.

13. The equipment of claim 8, wherein the one or more diffusers are made of stainless steel, aluminum, carbon fiber, PVC, steel, galvanized steel, or any other metal or plastic alloy.

14. The equipment of claim 13, wherein the one or more diffusers have an external diameter ranging from 9 mm to 200 mm, an internal diameter from 7 mm to 140 mm and a length from 10 cm to 250 cm.
